(19) United States
(12) Patent Application Publication
(10) Pub. No.: US 2010/0150488 A1
(43) Pub. Date: Jun. 17, 2010

(54) Bearing assembly

(75) Inventors: Thilo Beck, Werneck (DE); Rico Dittmar, Schweinfurt (DE); Gerhard Haas, Dittelbrunn (DE); Bernd Stephan, Schweinfurt (DE); Arno Stubenrauch, Aidhausen (DE); Peter Volpert, Bergrheinfeld (DE); Thomas Will, Schweinfurt (DE); Anastazi Sarigiannis, Livonia, MI (US)

Correspondence Address: Mark A. Ussai;SKF USA Inc., 1111 Adams Avenue, Norristown, PA, 19403, US

(73) Assignee: Aktiebolaget SKF, Goteborg (SE)

(21) Appl. No.: 12/386,240

(22) Filed: Apr. 15, 2009

(30) Foreign Application Priority Data
Dec. 17, 2008 (DE) 10 2008 062 740.2
Jan. 31, 2009 (DE) 10 2009 007 014.1

(51) Int. Cl. F16C 43/00

(52) U.S. Cl. 384/537

(57) ABSTRACT

A bearing assembly includes a first bearing comprising a first inner ring and a second bearing comprising a second inner ring. A sleeve-shaped spacer is disposed between and axially separates the first and second inner rings. The spacer has at least one at least partially circumferentially-extending cantilever arm extending from at least one axial end of the spacer and is configured to at least partially overlap one of the first and second inner rings in the axial direction. The cantilever arms may be annular-shaped and may engage the respective first and second inner rings in a location fit or an interference fit.

### CROSS-REFERENCE

This application claims priority to German patent application no. 10 2009 007 014.1, filed on Jan. 31, 2009, which is incorporated fully herein by reference.

### TECHNICAL FIELD

The present invention generally relates to bearings and bearing assemblies, which may preferably be utilized in wheel bearings, e.g., truck wheel bearings, in certain applications of the present teachings.

### BACKGROUND ART

Some known bearing assemblies for wheel bearings utilized in trucks comprise two inner rings or races having different bore diameters. A frustum-shaped connecting piece or spacer is disposed between the differently-sized inner rings and serves to set the spacing of the inner rings in the axial direction. The inner rings and spacer are mounted on a non-driven wheel axle or axle spindle having an outer shape that generally corresponds to the shape of the inner bores of the inner rings and spacer. Roller elements are disposed between the inner rings, which contact the axle spindle and do not rotate during driving, and a corresponding set of outer rings or races, thereby forming inboard and outboard roller bearings. These roller bearings enable a wheel hub coupled to a wheel to rotate about the non-driven axle spindle when the vehicle is driven.

To simplify mounting of the wheel mount on the wheel axle, the inner ring having the smaller diameter is disposed, with respect to the insertion direction of the wheel axle, on the forward or front side of the wheel mount and the inner ring having the larger diameter is disposed on the rearward side of the wheel mount. The circumferences of the wheel axle or axle spindle correspond to the bore diameters of the inner rings and the spacer, such that, during mounting of the wheel mount on the wheel axle, the segment of smaller circumference is initially guided through the larger-diameter inner ring and the spacer. This mounting procedure can thus be performed in a relatively simple manner. As soon as the axle spindle segment having the smaller circumference is completely inserted into the inner ring having the smaller diameter, the frustum-shaped segment of the axle spindle is located in the corresponding frustum-shaped segment of the spacer and the segment of the axle spindle having the larger circumference is located in the inner ring of larger diameter.

In such a three-part construction, axial shifting or displacement of the inner rings relative to the spacer may not be sufficiently restricted or prevented during the mounting procedure. Further, if the junction of the respective inner rings and the spacer is not relatively smooth, the axle spindle could bump against the spacer or the smaller inner ring during insertion into the wheel bearing assembly, which would hinder the wheel mounting procedure.

### SUMMARY

It is an object of the present invention to provide an improved bearing and/or bearing assembly.

According to first aspect of the present teachings, a bearing assembly preferably includes a first bearing comprising a first inner ring and a second bearing comprising a second inner ring. A sleeve-shaped spacer is preferably disposed between and axially separates the first and second inner rings. Further, the spacer preferably includes at least one at least partially circumferentially- or radially-extending cantilever arm axially extending from at least one axial end of the spacer and being configured to at least partially overlap one of the first and second inner rings in the axial direction. Preferably, the inner bores of the inner rings and the spacer are configured to receive an axle spindle of a wheel axle.

The spacer may have a constant inner bore diameter along its axial length and thus may be substantially cylindrical shaped. In this case, the inner rings may have the same inner bore diameter, which matches the constant inner bore diameter of the spacer.

In the alternative, the spacer may have a tapered inner bore diameter and thus may be, e.g., substantially frustum shaped or conical shaped, although other tapered shapes fall within the scope of the present teachings. In this case, the inner rings are preferably sized differently so as to at least substantially match the different inner bore diameters of the respective axial ends of the spacer. More preferably, the inner bores of the bearing assembly at each junction of inner ring and spacer are flush or substantially flush so that no protrusion extends into the bore space. In this tapered spacer embodiment, the inner bore diameters preferably smoothly transition or change from a larger diameter to a smaller diameter. The transition or change of bore diameters may be continuous or discontinuous.

The cantilever arm preferably extends radially outward of and overlaps the outer surface of the adjacent inner ring, which may preferably engage the cantilever arm in a friction or interference fit. In other embodiments, a location or shape fit of the cantilever arm(s) and the respective inner ring(s) may be sufficient.

According to a second aspect of the present teachings, a bearing assembly preferably comprises at least two bearings separated in the axial direction. The bearings each preferably comprise at least one inner ring and these two inner rings preferably have differently-sized bore diameters. A structure having a hollow (e.g., sleeve-like), substantially frustum-like, conical or tapered shape (hereinafter, a “spacer”) is disposed between the two inner rings and preferably at least substantially defines the axial separation or spacing between the two inner rings. The inner diameter at each axial end region of the spacer preferably corresponds to the respective bore diameter of the bordering or adjacent inner ring, so that contact points are defined between the spacer and each respective inner ring. At each contact point, the spacer has at least one at least partially circumferentially- or radially-extending cantilever arm that is formed such that it at least partially overlaps the respective inner ring in the axial direction. The cantilever arm enables the spacer and respective inner ring to be secured or prevented from shifting or displacing in the radial direction, thereby expediting the wheel mounting procedure.

The spacer is preferably embodied as one integral piece in order to avoid the necessity of providing one or more additional retaining elements for securing the spacer. However, multiple piece spacers are also within the scope of the present teachings.

In addition, the inner rings and the spacer are preferably arranged relative to each other so that the inner bores smoothly transition at each junction between an inner ring and the spacer. In preferred wheel bearing assembly embodiments, this design feature enables the axle or axle spindle to be inserted as simply and smoothly as possible. That is, there is preferably no elevation or unevenness at the junctions at least in the insertion direction of the axle, so that the axle spindle does not bump or get caught on any internal structure during the wheel mounting procedure.

In a further representative embodiment, at least one of the cantilever arms is formed such that it overlaps the adjacent inner ring on the outside thereof with respect to the radial direction. In this arrangement, the axle spindle is prevented from contacting the cantilever arm during the wheel mounting procedure, so that damage is avoided while still securely fixing the spacer.

In a preferred aspect of the present teachings, the cantilever arms extend outwardly in the axial direction from both axial ends of the spacer. Such a spacer is manufacturable in a particularly simple manner. For example, the cantilever arm can be produced from a pre-fabricated, frustum- or conical-shaped pipe by removing some material from the inside surface at each axial end, so that a larger inner bore diameter is provided in the end sections of the spacer. The inner bore diameter of the cantilever arm preferably substantially corresponds to (e.g. slightly smaller than, slightly larger than or the same as) the respective outer diameter of the to-be-overlapped inner ring. The material can be removed, e.g., by lathing.

In the alternative, at least one of the cantilever arms is formed such that it overlaps the corresponding inner ring on the inside thereof with respect to the radial direction. This embodiment of the cantilever arm offers a simple possibility for securely fixing the spacer in its position. This embodiment can be produced, e.g., by lathing the outer axial end of a frustum-shaped pipe to provide an end region having a reduced outer diameter. The adjacent inner ring then overlaps the cantilever arm on the outer, lathed surface of the cantilever arm.

Naturally, spacers according to the present teachings may be manufactured in other ways known to the person of skilled in the art.

In addition or in the alternative, the cantilever arms are each formed so as to completely extend around the radial direction. Such an embodiment has the greatest stability, so that the spacer remains securely in the desired position even under large loads.

In addition or in the alternative, in the area of an overlapping surface defined by the overlapping of the cantilever arm and the inner ring, the cantilever arm and/or the inner ring is/are formed such that a friction-fit or interference fit results between the cantilever arm and the inner ring. In this embodiment, the components are also prevented from shifting in the axial direction, so that they can, e.g., be pre-mounted and prepared for the fitting in a wheel suspension. Such a bearing assembly exhibits high stability and can be pre-mounted in a simple manner.

The term ‘cantilever arm’ as utilized herein to identify a structural feature associated with the spacer may be replaced or substituted, e.g., with the term ‘projection’, ‘protrusion’, ‘flange’, ‘shoulder’, ‘stop’, etc., as all such structural features may be used interchangeably in the present teachings to provide a structure for engaging, contacting or joining with the adjacent inner ring.

The term ‘spacer’ may also be replaced or substituted with the term ‘spacer sleeve’, ‘sleeve’, ‘journal’, ‘connecting piece’, etc. The spacer serves, in part, to define an axial separation or spacing between two inner rings and to provide a hollow cavity for receiving, e.g., an axle or other type of shaft. The spacer also preferably includes at least one structural feature utilized in preventing or restricting movement of the spacer and the inner ring(s) in the axial and/or radial direction of the bearing assembly.

The terms ‘inner ring’ and ‘outer ring’ may also be replaced or substituted with the terms ‘inner race’ and ‘outer race’, respectively.

In accordance with another aspect of the present teachings, one or more of the bearings is embodied as a roller bearing and preferably includes one or more roller bearing elements or bodies, which is/are preferably disposed between the inner ring of the bearing and an outer ring or race of the bearing.

In addition or in the alternative, a bearing assembly according to the present teachings may be a component of a wheel bearing, e.g., for usage in truck applications.

In another aspect of the present teachings, a bearing assembly includes a first bearing comprising a first inner ring and a second bearing comprising a second inner ring. A sleeve-shaped spacer is disposed between and axially separates the first and second inner rings. The spacer has at least one at least partially circumferentially-extending cantilever arm extending from at least one axial end of the spacer and is configured to at least partially overlap one of the first and second inner rings in the axial direction. The cantilever arms may be annular-shaped and may engage the respective first and second inner rings in a location fit or an interference fit.

Further advantages and embodiments of the invention are derivable from the following description of exemplary embodiments together with the appended drawing.

### BRIEF DESCRIPTION OF THE DRAWING

FIG. 1 shows a preferred exemplary embodiment of the invention in schematic radial cross section.

### DETAILED DESCRIPTION OF THE PREFERRED EMBODIMENTS

Each of the additional features and teachings disclosed below may be utilized separately or in conjunction with other features and teachings to provide improved bearings and/or bearing assemblies, as well as methods for designing, constructing and using the same. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

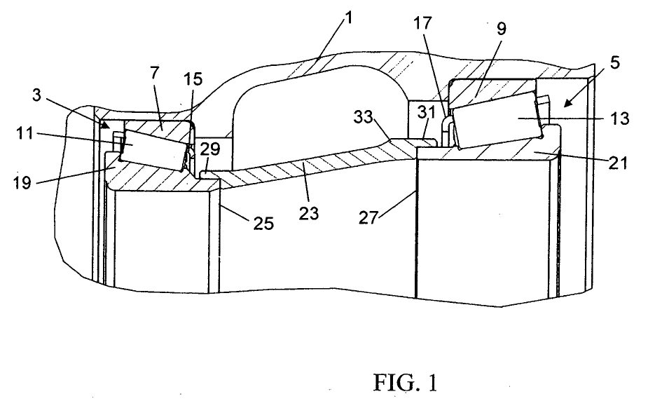

A first representative bearing assembly, which is preferably utilized as a wheel bearing, is illustrated in radial cross section in FIG. 1. Only components relevant for the description of the exemplary embodiment are depicted and described in the following. Other features may be utilized according to the known art and thus need not be explicitly described herein.

The representative wheel bearing comprises a support unit or wheel hub 1 for affixing a wheel rim on the wheel bearing. Two roller bearings 3 and 5 function to rotatably support the support unit 1 on a wheel axle or axle spindle, which is not depicted here. The roller bearings 3 and 5 each have an outer ring 7 and 9, respectively, one or more roller bodies 11 and 13, respectively, cages 15 and 17, respectively, and inner rings 19 and 21, respectively. Although a single roller body 11, 13 is depicted in the drawing for each roller bearing, a plurality of roller bodies are preferably used in preferred embodiments. The inner rings 19 and 21 preferably have differently-sized bore diameters, wherein the smaller inner ring 19 is disposed forward of the larger inner ring 21 with reference to the insertion direction of the wheel axle. That is, the wheel axle insertion direction is from right to left according to the illustration of FIG. 1.

The roller bearings 3 and 5 are arranged so as to be spaced in the axial direction. A spacer sleeve 23 (hereinafter simply “spacer 23”) is disposed between the roller bearings 3 and 5. The spacer 23 may be in contact with the inner rings 19 and 21 and thus determine the axial spacing of the roller bearings 3 and 5. However, one or more structures, such as a sealing element discussed below, may be interleaved between the spacer 23 and the inner rings 19, 21 in certain applications of the present teachings.

The spacer 23 is preferably sleeve-shaped, i.e. hollow, so that a shaft or wheel axle can extend through it. In further preferred embodiments, the spacer 23 may be substantially frustum- or conical-shaped, e.g., it may be tapered, such that the bore diameter of the spacer 23 decreases along the axial direction of the spacer 23. The inner and/or outer diameters of the spacer 23 may decrease in a continuous manner, a discontinuous manner or a combination of the two. However, in embodiments in which the inner rings 19 and 21 have identical or substantially identical sizes and/or bore diameters, the spacer 23 may preferably be cylinder-shaped or substantially cylinder-shaped.

At the circumferentially-extending contact points 25 and 27, the bore diameters of the spacer 23 at each axial end substantially match the bore diameter of the bordering or adjacent inner ring 19 or 21, respectively. In certain applications of the present teachings, the bore diameters of the inner rings 19, 21 can be slightly smaller or larger than the adjacent diameters of the spacer 23. In such a design, the component having the smaller bore diameter should always be initially disposed further forward with reference to the insertion direction of the wheel axle. In this case, no protrusions will result within the bore that would hinder the insertion of the wheel axle due to hitting or bumping against the protrusions. The spacer 23 may also optionally include segments having a constant bore diameter near each contact point 25 and 27.

An at least partially circumferentially-extending or radially-extending cantilever arm 29, 31 is preferably disposed at each axial end of the spacer 23 adjacent to the respective contact points 25 and 27. The cantilever arms 29, 31 are each preferably formed such that they surround the adjacent inner rings 19, 21, respectively, in the radial direction. In this case, the cantilever arms 29, 31 have an inner circumference that substantially corresponds to the outer circumference of the respective inner ring 19, 21. Thus, at least a shape-fit or location fit enclosure of the inner rings 19 and 21, respectively, is achieved. The inner rings 19, 21 may fit in the cantilever arms 29, 31, respectively, in an interference or friction fit. In either case, it is advantageous to prevent or at least substantially minimize movement or displacement of the spacer 23 relative to the inner rings 19 and 21 at least in the radial direction. In this case, the spacer 23 is retained in the illustrated position, so that the shaft or wheel axle is insertable without problems.

The cantilever arms 29 and 31 can be produced, e.g., by lathe removal of material from a blank of the spacer 23, e.g. a frustum-shaped pipe having a uniform thickness. In one representative manufacturing embodiment, material is removed from the inside in the end portions of the blank, so that the cantilever arms 29 and 31 result. In this case, the inner surfaces of the cantilever arms 29 and 31 overlap the inner rings 19 and 21, respectively, thereby forming at least a shape-fit or location fit. If the inner diameter of the cantilever arm is slightly less than the outer diameter of the corresponding inner ring, an interference or friction fit will result. The most appropriate fit between the spacer 23 and the inner rings 19, 21 will depend upon the particular design and operational demands.

The material thickness at each axial end of the spacer 23 can also be increased in order to be able to produce a more stable cantilever arm. In other words, the blank of the spacer 23 is not required to have a uniform thickness prior to formation of the cantilever arms 29, 31.

The cantilever arms 29 and 31 may extend partially or entirely around the circumference of the spacer 23.

In order to produce a junction that is as uniform and stable as possible between an obliquely-extending (tapered), middle section of the spacer 23 and the cantilever arms 29 and 31, the spacer 23 may preferably include an axially-extending section having a constant outer diameter that is disposed adjacent to each of the cantilever arms 29 and 31, respectively. Particularly stable cantilever arms 29 and 31 having a constant material thickness can be produced according to this embodiment. For additional stabilization, the spacer 23 may further include an optional thickened portion 33 having an increased material thickness adjacent to the cantilever arm 31. This thickened portion 33 can also be formed adjacent to the cantilever arm 29 or adjacent to both cantilever arms 29 and 31.

For mounting of the wheel bearing assembly, it is advantageous if the inner rings 19 and 21 remain fixed or immovable relative to the spacer 23 in the axial direction. By appropriately designing and dimensioning the cantilever arms 29 and 31, a press-fit, friction-fit or interference fit can be attained between the inner rings 19 and 21, respectively, and the spacer 23, so that a clamping force is maintained after the spacer 23 is coupled to the inner rings 19, 21, thereby preventing relative movement of the inner rings and the spacer in the axial direction. Thus, the clamping force that prevents relative axial movement can be generated, e.g., by compression. Methods are known to the person skilled in the art for producing a friction-fit of two or more pipe-like structures and thus need not be elucidated herein.

In addition or in the alternative, e.g., one or both of the overlapping portions of the inner rings 19 and 21 and the cantilever arms 29 and 31, respectively, can be provided with rough surfaces so as to inhibit relative axial movement after the inner rings 19, 21 have been inserted into the recesses defined by the respective cantilever arms 29, 31.

A sealing element, e.g., a rubber ring, may preferably be provided at one or both contact point(s) 25 and 27 between the spacer 23 and the inner rings 19 and 21, respectively. The one or more sealing elements function to seal or isolate the roller bearing elements of the assembly relative to the inner bore of the assembly designed to receive the wheel axle, so that no moisture can permeate into the roller bearing elements. In the alternative, the inner sides of the cantilever arms 29 and 31 can be coated with a sealing fluid or lacquer, so that a sealing effect results after the assembly.

The opposing front or terminal sides of the inner rings 19 and 21, as well as the spacer 23, may be flat, because they are not required to provide a fixing or retaining function in the axial direction due to the design of the cantilever arms 29, 31. Consequently, the bearing clearance can be maintained as low as possible.

As indicated above, the present teachings are not limited to embodiments, in which the two inner rings have different bore sizes and the spacer is tapered. Suitable spacers can also be utilized in bearing assemblies, in which the inner rings have the same inner diameter. In this case, the spacer is not embodied as frustum-shaped, but rather as cylinder-shaped having an inner diameter that at least substantially matches the bore diameter(s) of the inner rings. The cantilever arms can be designed in an analogous manner as was described above in the detailed representative embodiment, so that axial and/or radial shifting is prevented in a simple manner.

Further teachings that may be advantageously combined with the present teachings are provided in U.S. patent application Ser. No. 12/384,704, filed on Apr. 8, 2009, which is incorporated fully herein by reference.

### REFERENCE NUMBER LIST

1 support unit
3, 5 roller bearing
7, 9 outer ring
11, 13 roller body
15, 17 cage
19, 21 inner ring
23 spacer
25, 27 contact point
29, 31 cantilever arm A
33 thickened portion

1. A bearing assembly comprising:
a first bearing comprising a first inner ring,
a second bearing comprising a second inner ring and
a sleeve-shaped spacer disposed between and axially separating the first and second inner rings, the spacer having at least one at least partially circumferentially-extending cantilever arm projecting from at least one axial end of the spacer and being configured to at least partially overlap one of the first and second inner rings in the axial direction.

2. A bearing assembly according to claim 1, wherein the spacer has a first at least partially circumferentially-extending cantilever arm projecting from a first axial end of the spacer and a second at least partially circumferentially-extending cantilever arm projecting from a second axial end of the spacer.

3. A bearing assembly according to claim 2, wherein the first and second inner rings have differently-sized bore diameters and the sleeve-shaped spacer has one of a substantially frustum shape, a substantially conical shape and a tapered shape, wherein the first axial end of the spacer has a first inner bore diameter that matches the bore diameter of the first inner ring and the second axial end of the spacer has a second inner bore diameter that matches the bore diameter of the second inner ring, wherein the inner surfaces of the spacer and the first and second inner rings join in a flush manner.

4. A bearing assembly according to claim 3, wherein the first cantilever arm at least partially overlaps a radially outer surface of the first inner ring and the second cantilever arm at least partially overlaps a radially outer surface of the second inner ring.

5. A bearing assembly according to claim 4, wherein the first and second cantilever arms extend completely around the circumference of the spacer.

6. A bearing assembly according to claim 5, wherein the first inner ring is location fit in the first cantilever arm.

7. A bearing assembly according to claim 5, wherein the first inner ring is frictionally fit in the first cantilever arm.

8. A bearing assembly according to claim 5, wherein the first inner ring is press fit in the first cantilever arm.

9. A bearing assembly according to claim 5, wherein at least one overlapping surface of the first inner ring and the first cantilever arm has a rough surface configured for frictional engagement of the first inner ring and the first cantilever arm.

10. A bearing assembly according to claim 5, further comprising at least one roller bearing element supported by the first inner ring and at least one roller bearing element supported by the second inner ring.

11. A bearing assembly according to claim 10, further comprising a wheel hub rotatably supported by the roller bearing elements, wherein the bores of the first inner ring, the second inner ring and the spacer are configured to receive a tapered wheel axle.

12. A bearing assembly according to claim 11, wherein the spacer includes a first axially-extending section having a first constant outer diameter disposed adjacent to the first cantilever arm and a second axially-extending section having a second constant outer diameter disposed adjacent to the second cantilever arm, the second constant outer diameter being different than the first constant outer diameter.

13. A bearing assembly according to claim 3, wherein the first and second cantilever arms are annular-shaped.

14. A bearing assembly according to claim 13, wherein the first cantilever arm at least partially overlaps a radially outer surface of the first inner ring.

15. A bearing assembly according to claim 3, wherein the spacer includes a first axially-extending section having a first constant outer diameter disposed adjacent the first cantilever arm and a second axially-extending section having a second constant outer diameter disposed adjacent the second cantilever arm, the second constant outer diameter being different than the first constant outer diameter.

16. A bearing assembly comprising:
a first bearing comprising a first inner race having a first inner bore diameter,
a second bearing comprising a second inner race having a second inner bore diameter different from the first inner bore diameter, and
a tapered spacer disposed between and axially separating the first and second inner races, the spacer having a first annular shoulder axially extending from a first axial end of the spacer and a second annular shoulder axially extending from a second axial end of the spacer, wherein at least a portion of the first inner race is fit in or on the first shoulder and at least a portion of the second inner race is fit in or on the second shoulder, the first and second shoulders being configured to prevent relative movement of the spacer and the first and second inner races in the radial direction.

17. A bearing assembly according to claim 16, wherein the spacer includes a first axially-extending section having a first constant outer diameter disposed adjacent the first shoulder and a second axially-extending section having a second constant outer diameter disposed adjacent the second shoulder, the second constant outer diameter being different than the first constant outer diameter.

18. A bearing assembly according to claim 16, further comprising:
at least one roller bearing element supported by the first inner race,
at least one roller bearing element supported by the second inner race and
a wheel hub rotatably supported by the roller bearing elements, wherein the bores of the first inner race, the second inner race and the spacer are configured to receive a tapered wheel axle spindle.

19. A bearing assembly according to claim 16, wherein at least a portion of the first inner race is frictionally fit in the first shoulder and at least a portion of the second inner race is frictionally fit in the second shoulder.

20. A bearing assembly according to claim 19, wherein the spacer has a substantially frustum shape, the first axial end of the spacer has a first inner bore diameter that matches the bore diameter of the first inner race and the second axial end of the spacer has a second inner bore diameter that matches the bore diameter of the second inner race, wherein the inner bore surface of the first inner race is flush with the first inner bore diameter surface of the spacer and the inner bore surface of the second inner race is flush with the second inner bore diameter surface of the spacer.
